(19) United States
(12) Patent Application Publication
(10) Pub. No.: US 2022/0398660 A1
(43) Pub. Date: Dec. 15, 2022

(54) SYSTEM AND METHOD FOR COMPUTATIONAL SHELF FORECASTING

(71) Applicant: SRAX, Inc., Westlake Village, CA (US)

(72) Inventors: Chung Vang Lei, Pasadena, CA (US); Christopher Miglino, Westlake Village, CA (US); Timothy D. Walton, Wichita, KS (US)

(73) Assignee: SRAX, Inc., Westlake Village, CA (US)

(21) Appl. No.: 17/583,771

(22) Filed: Jan. 25, 2022

Related U.S. Application Data
(60) Provisional application No. 63/209,328, filed on Jun. 10, 2021.

(51) Int. Cl. G06Q 40/04; G06F 40/205; G06F 16/33; G06F 16/34

(52) U.S. Cl. CPC G06Q 40/04; G06F 40/205; G06F 16/3334; G06F 16/34

(57) ABSTRACT

Systems and methods for computational shelf forecasting are described. This may include receiving, by a computational action system, a network document associated with a corporate entity; initiating a data parsing process on the network document to determine official corporate filing data associated with the corporate entity; using the official corporate filing data associated with the corporate entity, determining a target stock price associated with a subset of shelf availability and a corresponding date of the target stock price; receiving, by the computational action system via a user interaction at a user interface, future data associated with the corporate entity; adjusting one or more shelf statuses using the future data; and providing a forecast action based on the one or more shelf statuses.

### CROSS-REFERENCE TO RELATED APPLICATIONS

This application claims the benefit of U.S. Provisional Application No. 63/209,328 filed Jun. 10, 2021, which is hereby incorporated herein by reference in its entirety.

### TECHNICAL FIELD

The present disclosure relates generally to data analytics and machine learning and in particular, some implementations may relate to computational actions relating to shelf forecasting.

### DESCRIPTION OF RELATED ART

A “shelf offering” is a Securities and Exchange Commission (SEC) provision that allows an equity issuer (e.g., corporation, etc.) to register a new issue of securities without having to sell the entire issue at once. The issuer can instead sell portions of the issue over a three-year period without re-registering the security or incurring penalties. During this period, the issuer may still file quarterly or annual disclosures with the SEC, even if it has not issued any securities under the offering. If the three-year window is close to expiring and the equity issuer did not sell all of the securities in the shelf offering, it can file replacement registration statements to extend it. One of the benefits of a shelf offering is that it enables the equity issuer to access stock markets quickly and with little additional administrative paperwork, when stock market conditions are more optimal for the issuer. The requirements on the shelf offering and the equity issuer are regulated by the SEC (e.g., $75 M cap, etc.).

When the equity issuer decides to issue securities to the stock market from the shelf offering, the equity issuer initiates a takedown action. These subsequent takedown actions can be made without additional SEC review. For example, suppose the computer chip market is heading toward a dramatic decline (e.g., with no natural materials available, etc.). In this case, it may not be a good time for an equity issuer associated with chip manufacturing to initiate a takedown action, as many investors will be pessimistic about companies in that sector. When the computer chip market rebounds (e.g., more natural materials are mined or discovered, etc.), the equity issuer can initiate the takedown action and act quickly to offer the securities to the stock market when market conditions are more favorable.

A shelf offering provides the equity issuer with some control over the process of offering new shares. It allows the equity issuer some control over the price of the shares by allowing the equity issuer to manage the supply of its security in the stock market. A shelf offering also enables the equity issuer to save on the cost of registration with the SEC by not having to re-register each time it wants to release new shares. If a company has a long term new security issuing plan, the process of shelf registration can allow it to address multiple issues of a particular security within a single registration statement. This can be more simple to create and manage for the equity issuer, since multiple filings are not required. This may also lower administrative costs for the business as a whole. Further, no maintenance requirements exist beyond standard reporting, because shelf registrations do not create an additional burden while they are waiting for issue.

Determining when to initiate the takedown action within a shelf offering is a computationally difficult process and better methods are needed. There are several factors that can be attributed to determining a desirable date to initiate the takedown action within the shelf offering. Part of the difficulty is that the date is in the future with little to help determine what will happen.

### BRIEF SUMMARY OF THE DISCLOSURE

According to various embodiments of the disclosed technology, systems, methods, and computer readable media are disclosed for providing computational shelf forecasting. The method may comprise, for example, receiving, by a computational action system, a network document associated with a corporate entity; initiating a data parsing process on the network document to determine official corporate filing data associated with the corporate entity; using the official corporate filing data associated with the corporate entity, determining a target stock price associated with a subset of shelf availability and a corresponding date of the target stock price; receiving, by the computational action system via a user interaction at a user interface, future data associated with the corporate entity; adjusting one or more shelf statuses and availability using the future data; and providing a forecast action based on the one or more shelf statuses.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates a computational action system, in accordance with the various embodiments disclosed herein.

FIG. 2 is illustrative of a network document with information associated with a corporate entity, in accordance with the various embodiments disclosed herein.

FIG. 3 is illustrative of the data processing module that may initiate a data parsing process, in accordance with various embodiments disclosed herein.

FIG. 3 is an example data cleaning process, in accordance with the various embodiments disclosed herein.

FIG. 4 is an illustrative example of an analytics data store incorporated with computational action system, in accordance with the various embodiments disclosed herein.

FIG. 5 is an illustrative analytics data structure incorporated with computational action system, in accordance with the various embodiments disclosed herein.

FIG. 6 is an illustrative user interface providing computational shelf forecasting, in accordance with the embodiments disclosed herein.

FIG. 7 is an illustrative user interface providing computational shelf forecasting, in accordance with the various embodiments disclosed herein.

FIG. 8 is an illustrative user interface providing computational shelf forecasting, in accordance with the various embodiments disclosed herein.

FIG. 9 is an illustrative user interface providing computational shelf forecasting, in accordance with the various embodiments disclosed herein.

FIG. 10 is an illustrative user interface providing computational shelf forecasting, in accordance with the various embodiments disclosed herein.

FIG. 11 is an illustrative user interface providing computational shelf forecasting, in accordance with the various embodiments disclosed herein.

FIG. 12 is an illustrative user interface providing computational shelf forecasting, in accordance with the various embodiments disclosed herein.

FIG. 13 is an illustrative user interface providing computational shelf forecasting, in accordance with the various embodiments disclosed herein.

FIG. 14 is an illustrative user interface providing computational shelf forecasting, in accordance with the various embodiments disclosed herein.

FIG. 15 is an illustrative user interface providing computational shelf forecasting, in accordance with the various embodiments disclosed herein.

FIG. 16 is an illustrative user interface providing computational shelf forecasting, in accordance with the various embodiments disclosed herein.

FIG. 17 is an illustrative user interface providing computational shelf forecasting, in accordance with the various embodiments disclosed herein.

FIG. 18 is an illustrative user interface providing computational shelf forecasting, in accordance with the various embodiments disclosed herein.

FIG. 19 is an illustrative user interface providing computational shelf forecasting, in accordance with the various embodiments disclosed herein.

FIG. 20 is an illustrative process for providing computational shelf forecasting, in accordance with the various embodiments disclosed herein.

FIG. 21 is an example of a computing system that may be used in implementing various features of various embodiments of the disclosed technology.

The figures are not exhaustive and do not limit the present disclosure to the precise form disclosed. It should be understood that the invention can be practiced with modification and alteration, and that the disclosed technology be limited only by the claims and the equivalents thereof.

### DETAILED DESCRIPTION

Embodiments disclosed herein provide systems and methods for providing computational shelf forecasting. This may include receiving, by a computational action system, a network document associated with a corporate entity; initiating a data parsing process on the network document to determine official corporate filing data associated with the corporate entity; using the official corporate filing data associated with the corporate entity, determining a target stock price associated with a subset of shelf availability and a corresponding date of the target stock price; receiving, by the computational action system via a user interaction at a user interface, future data associated with the corporate entity; adjusting one or more shelf statuses using the future data; and providing a forecast action based on the one or more shelf statuses.

Technical improvements are described throughout the application. For example, not all data may be applied to the shelf calculation in the current system. The available documents may include eight different filing types (e.g., Form 3, 4, 5, 424B5, S-3, 10Q, 10K, and DEF14A, etc.) within a predetermined or dynamic time frame (e.g., 3 years). After the system collects the available data, the system may initiate a data cleaning process, aggregate the data, and other processing features to identify redundant or unnecessary data that can be found in other forms or calculated based on other data sources. This could eliminate additional computations required by other systems and/or limit data transmissions for unnecessary data, creating additional bandwidth availability for other data transmissions.

Additionally, the data that the system uses to calculate the shelf status are collected in different filings over many years, and can provide real-time analytics for determining a time range for performing a takedown action. It would be infeasible to manually clean and analyze this amount of data in time for an urgent filing deadline or predicting an accurate time for performing a takedown action without the present system.

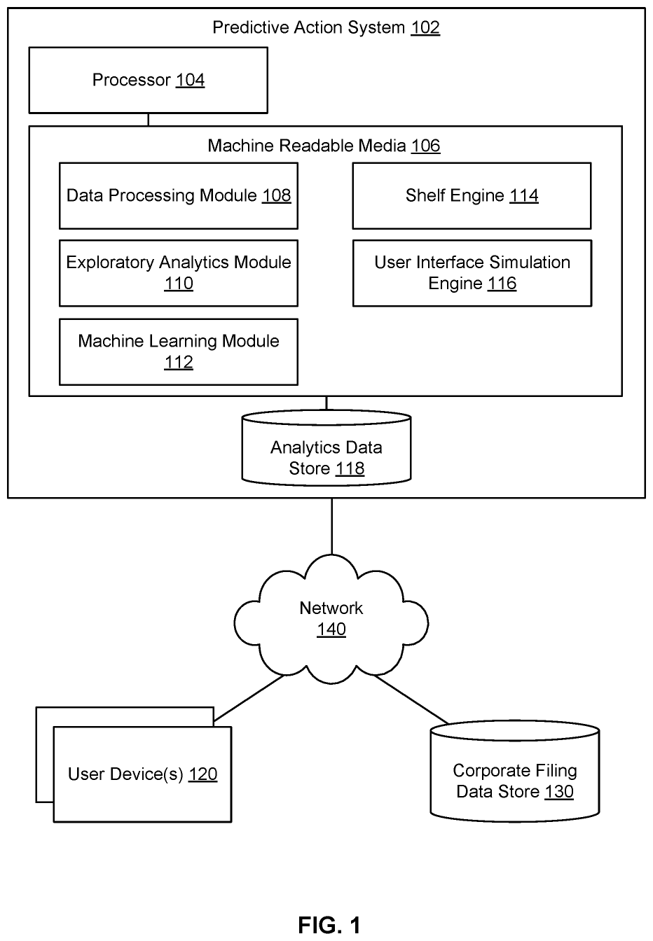

FIG. 1 illustrates a computational action system, in accordance with the various embodiments disclosed herein. In this illustration, computational action system 102 comprises processor 104 and machine readable media 106 and one or more data stores, including analytics data store 118, which may be in communication with one or more user devices 120 and corporate filing data store 130 via network 140. Machine readable media 106 may store executable instructions for performing various processes, including data processing module 108, exploratory analytics module 110, machine learning module 112, shelf engine 114, and user interface simulation engine 116.

Data processing module 108 may receive or access a network document from corporate filing data store 130. The network document may comprise information associated with a corporate entity. In some examples, the network document may include a financial form that was filed and/or published with the SEC, including From 3, From 4, From 5, 424B5, 10-K, 10-Q, DEF 14A, or S-3. In some examples, data processing module 108 may receive the data using an automated crawling process that accesses the SEC website and discovers new information.

In some examples, the data may comprise raw data collected from different data sources, such as the SEC and or other sources that provide stock market data in real time (e.g., Alpha Vantage®, etc.). In some examples, the data may comprise outstanding shares, affiliate shares, non-affiliate shares, sold of the common shares and the warrant, and shelf registration from SEC. In some examples, the data may comprise a current or historical stock price of the entity.

Accessing the network document may be implementing using an HTTP POST and/or an HTTP GET request method via the network 140. For example, the HTTP GET request method may request the computing device to scrape or receive the network document to determine the data enclosed in the body of the request message for storing (e.g., the SEC Form). In another example, the HTTP POST request method may modify data via a system user interface of user device 120 and computational action system 102. User device 120 may upload information from the computing device to computational action system 102. As part of a GET request, some data can be passed within the URL's query string, specifying search terms, date ranges, or other information that defines the query.

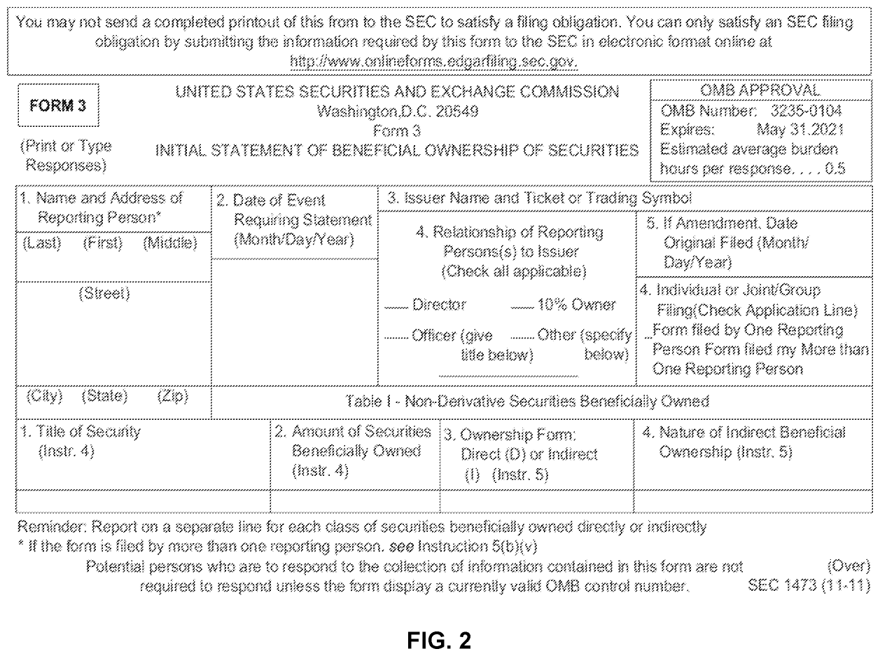

FIG. 2 is illustrative of a network document with information associated with a corporate entity, in accordance with the various embodiments disclosed herein. For example, the information may include a name of a reporting person, address, date of event requiring a financial statement, issuer name, ticker name, trading symbol, relationship of reporting person to issuer, original or amended filing date, title of security, amount of securities beneficially owned, direct or indirect ownership, nature of indirect beneficial ownership, and the like.

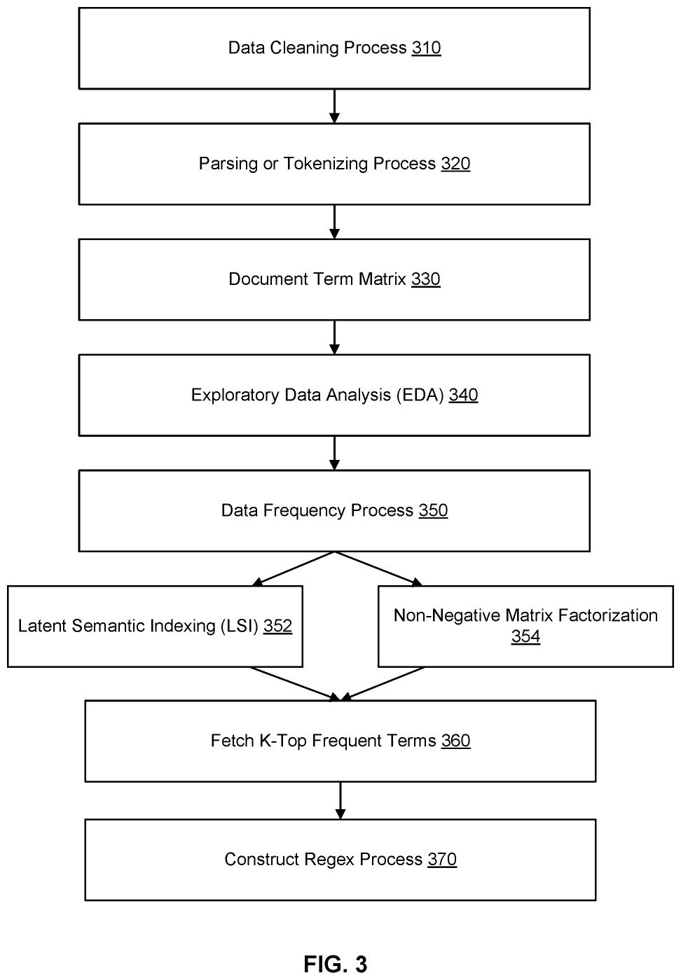

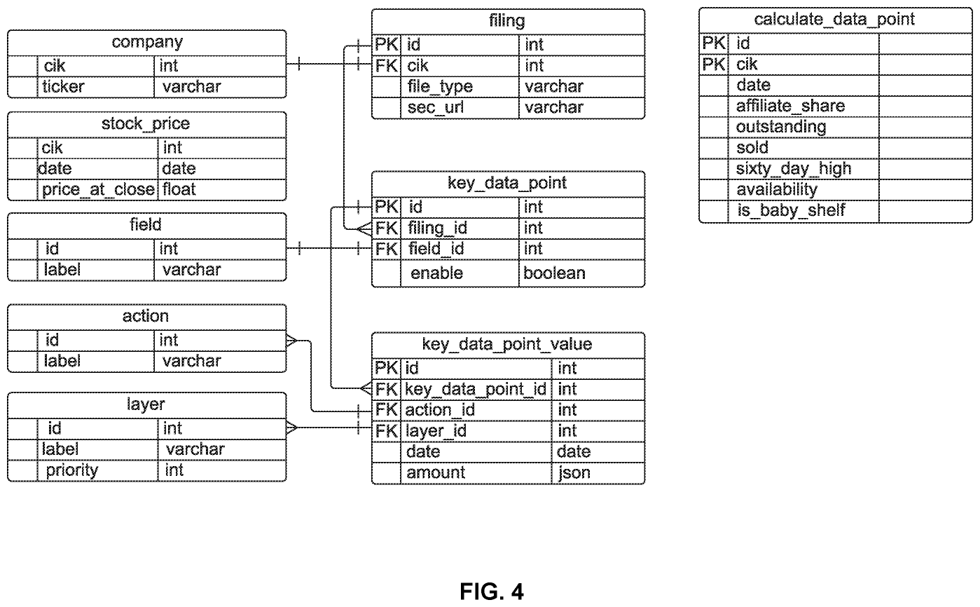

FIG. 3 is illustrative of the data processing module 108 that may initiate a data parsing process, in accordance with various embodiments disclosed herein. The data parsing process may include, for example, a data or text cleaning process 310, tokenizing process 320, generating a document term matrix 330, generating an exploratory data analysis (EDA) 340, initiating a data frequency process 350, initiating latent semantic indexing (LSI) 352 or non-negative matrix factorization (NMF or NNMF) 354, initiating a term fetch process 360, and/or initiating construction of a regular expression (also sometimes known as a regex) process 370. Each process is described in greater detail herein.

Data processing module 108 may initiate a data cleaning process 310 on the network document. The data cleaning process may remove additional spaces, periods, or other extraneous characters. In some examples, the data cleaning process 310 may include fixing or removing incorrect, corrupted, incorrectly formatted, duplicate, or incomplete data within the network document.

Data processing module 108 may initiate a parsing or tokenizing process 320 on the cleaned data. For example, the process may stem the data into a word stem, base, or root form (e.g., suffix stemming) by removing “ed,” “ing,” or “ly.” In some examples, the process may initiate a speech tagging process by generating a part of speech identifier based on its definition and/or its context (e.g., nouns, verbs, adjectives, adverbs, etc.). In some examples, the process may determine one or more N-grams for the cleaned data as including, for example, phonemes, syllables, letters, words, or base pairs. Each of these N-grams may be stored with analytics data store 118.

Data processing module 108 may generate a document-term matrix 330. For example, the document-term matrix may comprise rows that correspond to documents in the collection and columns correspond to the terms. In some examples, the value of the cells may be a raw count of a given term, or may include a weighting of the raw counts using as relative frequency/proportions and Term Frequency-Inverse Document Frequency (TF-IDF).

In some examples, one matrix may be determined per corporate or shelf filing from corporate filing data store 130. This may include one matrix for each of the one or more financial forms that were filed and/or published with the SEC (e.g., 424B5, S-3, 10K, 10Q, etc.).

Exploratory analytics module 110 may access analytics data store 118 to help convert the data to generate information (e.g., structure or relationships among the data points, shelf registration, full shelf availability, baby shelf status bars, etc.), insight (e.g., using analysis to extract the meaning from the data, including a target stock price in order to gain full shelf availability when the company is under Baby Shelf Rule (e.g., General Instruction I.B.6 to Form S-3, described further herein), visualizing the data on a chart, date to optimize value, etc.), forecasting (e.g., using future values entered by a user to calculate forecasted outcomes in the future, including full shelf availability, baby shelf status bars, target stock price in order to gain full shelf availability, etc.), and/or forecasting (e.g., forecast company behaviors by analyzing the historical data and computational analytics, etc.) relating to shelf offerings.

Exploratory analytics module 110 may comply with NASDAQ® Listing Rule 5635(d) (the NASDAQ 20% Rule). This rule may require shareholder approval of a transaction other than a public offering involving the sale, issuance, or potential issuance by a company of common stock (or securities convertible into or exercisable for common stock) equal to 20% or more of the common stock, or 20% or more of the voting power outstanding before the issuance for less than the greater of book or market value of the stock.

In some examples, exploratory analytics module 110 (with user interface simulation engine 116) may generate a notification when a future takedown action could violate the NASDAQ 20% Rule. For example, the user may provide a future takedown action via the GUI that is subject to the 20% rule. Exploratory analytics module 110 may compare the data corresponding with the future takedown action provided by the user with the NASDAQ 20% Rule stored in computational action system 102 to determine if the future takedown action would violate the rule. If so, the GUI may activate a notification (e.g., popup dialog, instruction incorporated with the GUI, etc.) that identifies the future takedown action as potentially violating the rule and/or suggesting to the user to review the formal rules in more detail. The notification may be automatically provided after failing the satisfy the rule.

In some examples, the exploratory analytics module 110 (with user interface simulation engine 116) may generate a notification when past takedown actions may have violated the NASDAQ 20% Rule. For example, the computational action system may analyze past takedowns actions that may be subject to the 20% rule. Exploratory analytics module 110 may compare the data corresponding with the past takedown actions with the NASDAQ 20% Rule stored in computational action system 102 to determine if the past takedown action may have violated the rule. If so, the GUI may activate a notification (e.g., popup dialog, instruction incorporated with the GUI, etc.) that identifies the past takedown action as having potentially violated the rule and/or suggesting to the user to review the formal rules in more detail and/or to verify the data entry regarding past takedowns and other pertinent data regarding the shelf status. The notification may be automatically provided after identifying a past takedown that may have violated the rule.

Exploratory analytics module 110 may comply with General Instruction I.B.6 to Form S-3 (the Baby Shelf Rules). This rule may require that a registrant with a market value of common equity held by non-affiliates (the public float) of less than $75 million may only sell under a Form S-3, during any 12-month period, with securities having an aggregate market value of not more than one-third of the public float of such registrant.

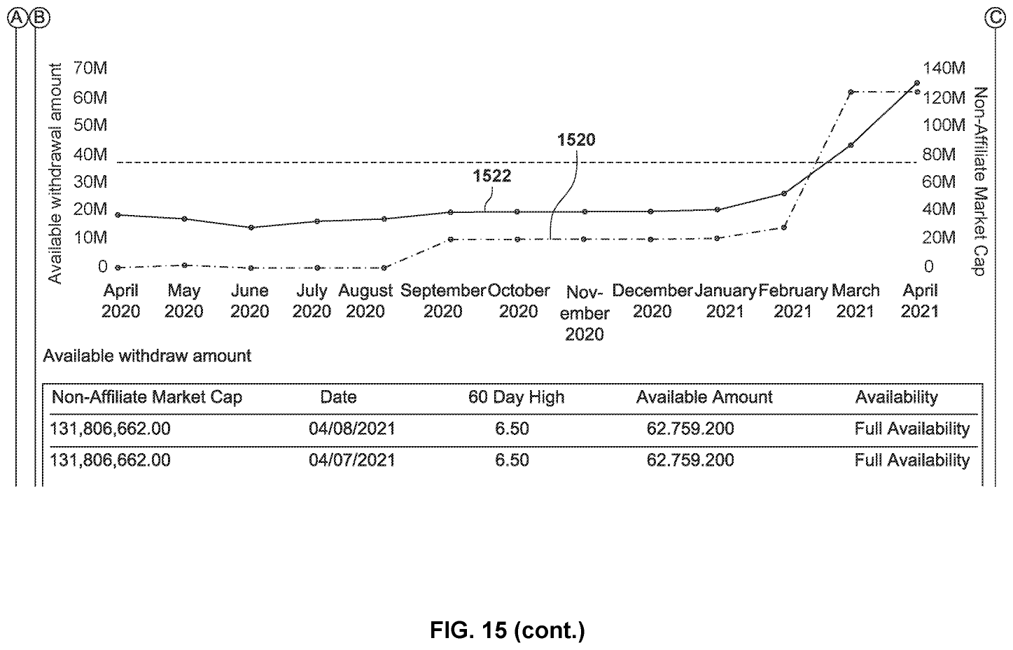

In some examples, exploratory analytics module 110 may search entity values available in the data store and filter any entity whose value is less than $75 million (or other value corresponding with the baby shelf rules). The data store may activate a flag that identifies the entity as being subject to the baby shelf rules. When the flag is activated, the GUI may automatically provide shelf data and other visualizations (see e.g., FIGS. 15-19, etc.) that may include additional icons or tabs to identify information associated with the baby shelf rules. As illustrated in FIG. 15(cont.), a dotted line may be provided at the $75 million value to correspond with an activated flag in the data store.

Machine learning module 112 may generate an exploratory data analysis (EDA) 340. The EDA may initiate an analysis of the cleaned data sets to summarize their main characteristics, generate statistical graphics, or other data visualization processes. In some examples, the EDA may maximize insight into a data set, uncover underlying structure, extract important variables, detect outliers and anomalies, test underlying assumptions, develop parsimonious models, and/or determine optimal factor settings.

Machine learning module 112 may initiate a data frequency process 350. The data frequency process may determine the number of occurrences or frequency of distinct values distributed within a given period of time or interval.

Machine learning module 112 may initiate latent semantic indexing (LSI) 352 or other Natural Language Process (NLP). For example, the process may analyze the relationships between the data by producing a set of concepts related to the terms. The process may assume that terms that are close in meaning will occur in similar pieces of text (e.g., using the distributional hypothesis).

LSI 352 may help determine a term matrix containing word counts per data source (e.g., rows represent unique words and columns represent each document). This may reduce the number of rows while preserving the similarity structure among columns. Various data sources may be compared by taking the cosine of the angle between the two vectors or the dot product between the normalizations of the two vectors formed by any two columns. Values close to 1 may represent very similar documents while values close to 0 may represent very dissimilar documents.

Machine learning module 112 may initiate non-negative matrix factorization (NMF or NNMF) 354. For example, matrix V may be factorized into two matrices W and H, with all three matrices having no negative elements.

Machine learning module 112 may initiate a term fetch process 360.

Shelf engine 114 may initiate a construction of a regex process 370.

Shelf engine 114 may aggregate various data points and calculate the shelf. For example, discrete data points from data store 118 may be determined as a daily data. An illustrative example of this data is shown at the bottom of FIG. 15. The daily data may be aggregated and used to generate a chart illustrating daily data, also shown in FIG. 15.

Shelf engine 114 may determine values for a forecasting mode. For example, in the forecasting mode, the user may prove future data points and shelf engine 114 can process the input into consideration. The future data points and consideration can be used to extend the result date range to the desired period (e.g., determined from user input at the GUI).

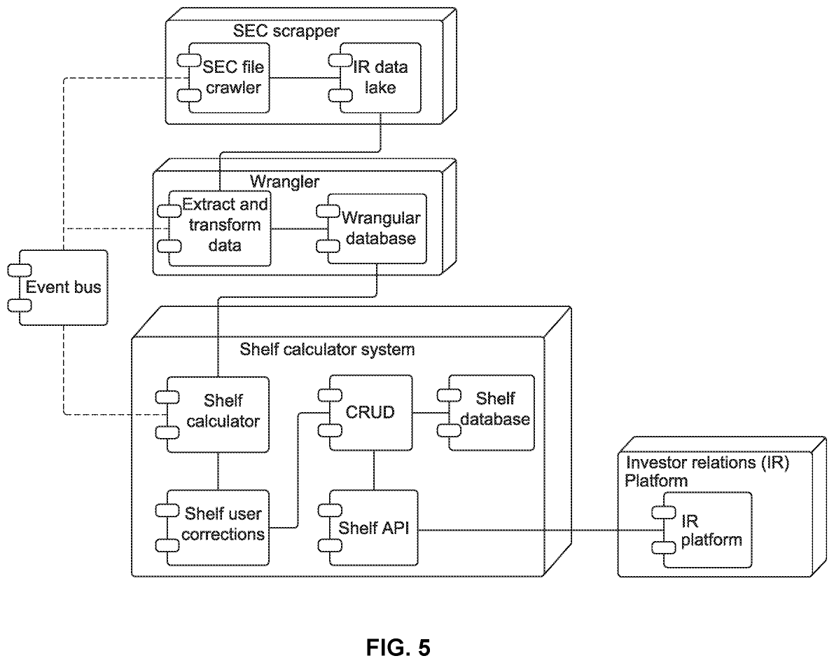

Each module and engine may store processed or unprocessed data in analytics data store 118. FIG. 4 is an illustrative example of an analytics data store 118 incorporated with computational action system 102, in accordance with the various embodiments disclosed herein. For example, the analytics data store 118 may comprise information about a company or entity (e.g., identifier, ticker symbol, etc.), stock price (e.g., identifier, date of the stock price, price at the closing bell, etc.), field (e.g., identifier, field label, etc.), action (e.g., identifier, field label, etc.), layer (e.g., identifier, label, priority of the corresponding data point, etc.), filing (e.g., identifier, foreign key identifier, file type, SEC URL, etc.), key data point (e.g., identifier, foreign key identifier, foreign filed identifier, true/false enabled, etc.), key data point value (e.g., identifier, foreign key data point identifier, foreign action identifier, foreign layer identifier, date of the key data point value, amount, etc.), and calculated data point (e.g., identifier, foreign identifier, date of the calculated data point value, affiliate share, outstanding, sold, sixty day high value, availability, true/false baby shelf, etc.). In some examples, the company or entity may correspond with multiple filings. Multiple companies or entities may correspond with each filing.

Three or more types of data may be stored in analytics data store 118, including key data points from SEC forms, associate data for lookup, and calculated data points or values. Key data points from SEC forms may begin with determining information from the forms. Each form from the entity's filing can have one or more key data points.

The calculated data point may include a sixty day high value. The sixty day high value may help determine the value calculation for the baby shelf rules. For example, when the sixty day high value of the underlying equity exceeds the minimum value to deactivate the baby shelf rules, this triggering event may act as a shelter extending the full shelf availability for the company for a certain amount of time in the future as may be regulated by the SEC and hence the corresponding company or entity may not trigger the baby shelf rules while operating under the sixty day shelter. The Boolean value corresponding with true/false baby shelf may be set to false.

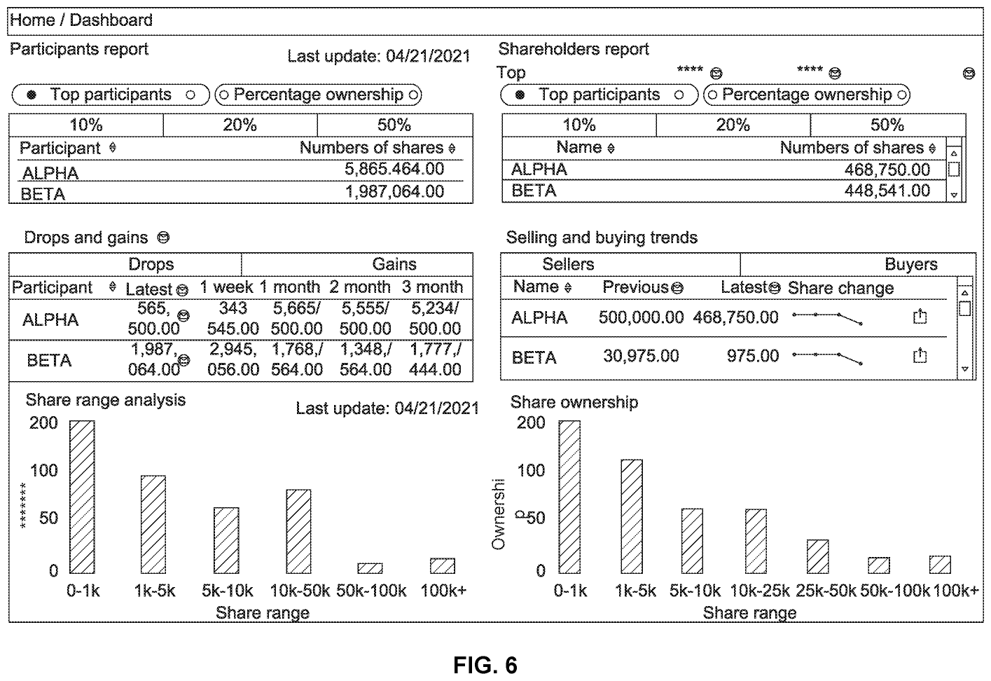

The SEC Uniform Resource Locator (URL) may be automatically determined. For example, the URL may correspond with a common top-level domain for filed forms with corporate filing data store 130 and portions of the URL may automatically be replaced with information from analytics data store 118. For example, a company identifier (or ticker) and file type identifier may be amended with a template URL to access a new uploaded form from the entity. In some examples, the scrapper (e.g., illustrated in FIG. 5) may use the determined URL to access the network document.

In some examples, only clean data may be stored in analytics data store 118. The raw data received from corporate filing data store 130 via network 140. As the raw data is received, it may be processed by computational action system 102 (e.g., on the fly or actively) and the processed data may be stored in analytics data store 118.

In some examples, the user can edit or overwrite the value of the data that was included with the SEC forms. The association tables in analytics data store 118 may be created after the data are normalized. Calculated values may be stored into a calculated values table based on the discrete data points that collected from the SEC forms.

In some examples, multiple data points may be stored from multiple sources and each of these data sources may correspond with a layered priority. As an illustrative example, data received from corporate filing data store 130 may receive a lower priority than data received from a user via GUI (e.g., FIG. 15) corresponding with a future takedown action or a data correction from a filed form. The priority may correspond with a layer priority range that is stored in analytics data store 118.

In some examples, computational action system 102 may be implemented in a cloud data structure that may perform calculations or execute stored procedures on the data. For example, the cloud data structure may implement a web scraper, event bridge, data log (e.g., audit), indexing, and the like for providing to the client user device.

FIG. 5 is an illustrative analytics data structure incorporated within the computational action system, in accordance with the various embodiments disclosed herein. Various components in FIG. 5 may help finish the process of data collection, extracting, aggregating, and display.

SEC scrapper job 510 may start at a predetermined time frame (e.g., during the midnight, daily, etc.). The SEC scrapper job 510 may download files from corporate filing data store 130 via network 140. In some examples, the files may be stored in analytics data store 118 or processed/cleaned and then stored in analytics data store 118. In some examples, every file may be transmitted as a single event for computational action system 102.

Once the event is complete, the SEC scrapper job 510 can push an event to the event bus 520. The event bus 520 can help other components of the system initiate processes through individually activated listening functions incorporated with each component.

Wrangler component 530 may implement different event listeners to listen for the event bus 520. When the shelf related event is pushed to the event bus 520, the wrangler 530 can receive the event and extract the data from the filing file(s). After we have the raw data, data processing module 108 can initiate a data cleaning process and post the clean data to the event bus 520.

Shelf calculation system 540 can listen for a shelf event from the wrangler component 530. When this component receives an event, shelf calculation system 540 can store the key data points into the shelf database and trigger/initiate the calculation process. The shelf calculation system 540 may implement a separate shelf filing-related listener from the wrangler component 530.

The shelf calculation system 540 may implement a CRUD module, corresponding with create, read, update, and delete. This module may receive the original data from corporate filing data store 130, the cleaned data from analytics data store 118, and/or the updated user data, which each may correspond with a layer priority. The duplicated data may be removed when higher layer priority data is received. The deduplicated data may be updated in the shelf database (e.g., analytics data store 118 in FIG. 1) on a continuous or real-time basis.

User interface simulation engine 116 may provide one or more computational shelf forecasting illustrations at the user interface of the user device 120. For example, the user may view a current shelf calculation as a number, table, chart, or other graphical representation. The user interface may be updated to show the entity's current shelf availability (e.g., availability within a 12-month period, etc.), shelf status (e.g., regular shelf or under baby shelf rule, etc.), or forecast of future shelf availability (e.g., receive user input of a date, shares, and stock price, and provide forecast of shelf availability, etc.). In another example, the data may be downloaded (e.g., comma separated variable (CSV), image format, etc.).

User interface simulation engine 116 may activate an icon or other notification on the GUI in response to a user action that corresponds with the 20% rule, baby shelf rules, and the like. The icon may identify, for example, how a future takedown action provided by the user may violate the baby shelf rules. As illustrated in FIG. 15, a dotted line may be provided at the $75 million value (or other value as determined by SEC regulations, or optionally chosen by the user) to correspond with an activated flag in the data store. In another example, a notification box may be provided on the GUI to instruct the user how much their stock price would need to change in order to be removed from the baby shelf rules.

User interface simulation engine 116 may provide an application programming interface (API) layer. The API layer may accept a user interaction from user device 120 and transmit the user interactions back to user interface simulation engine 116. In some examples, the user may provide additional data or overwrite existing data that can be incorporated in the computational shelf forecasting, including outstanding and/or shares (both affiliate and non-affiliate), dates to include in the calculation, and the like.

A shelf simulation may be generated (e.g., with shelf engine 114). For example, using different stock prices, dates, and other information, the shelf simulation can illustratively present the likely amount and timing for initiating a takedown action. An illustrative shelf simulation is provided with FIG. 15.

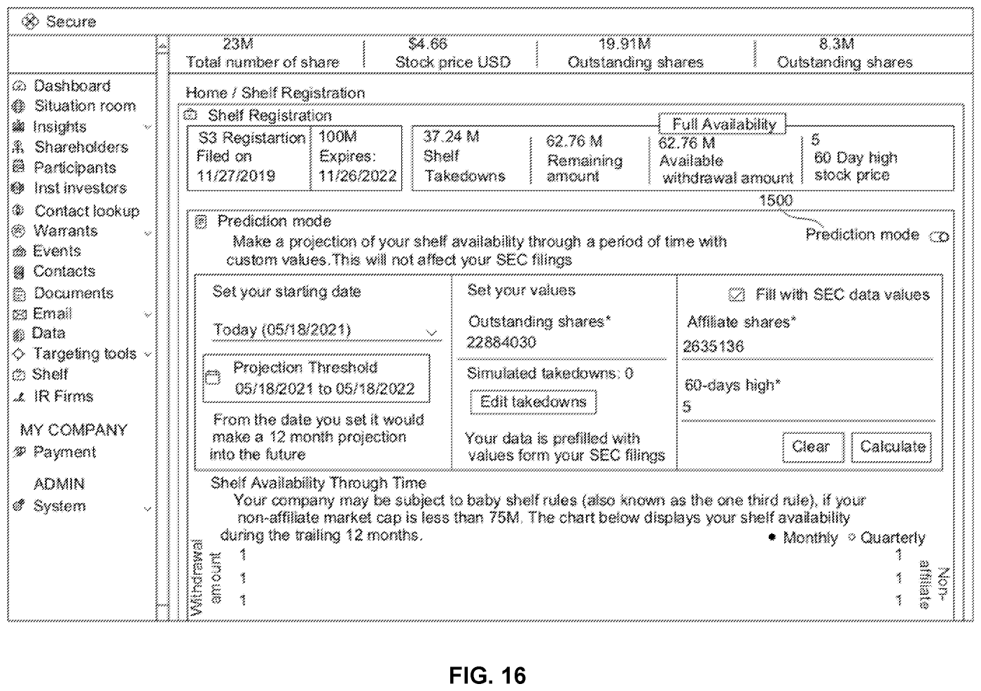

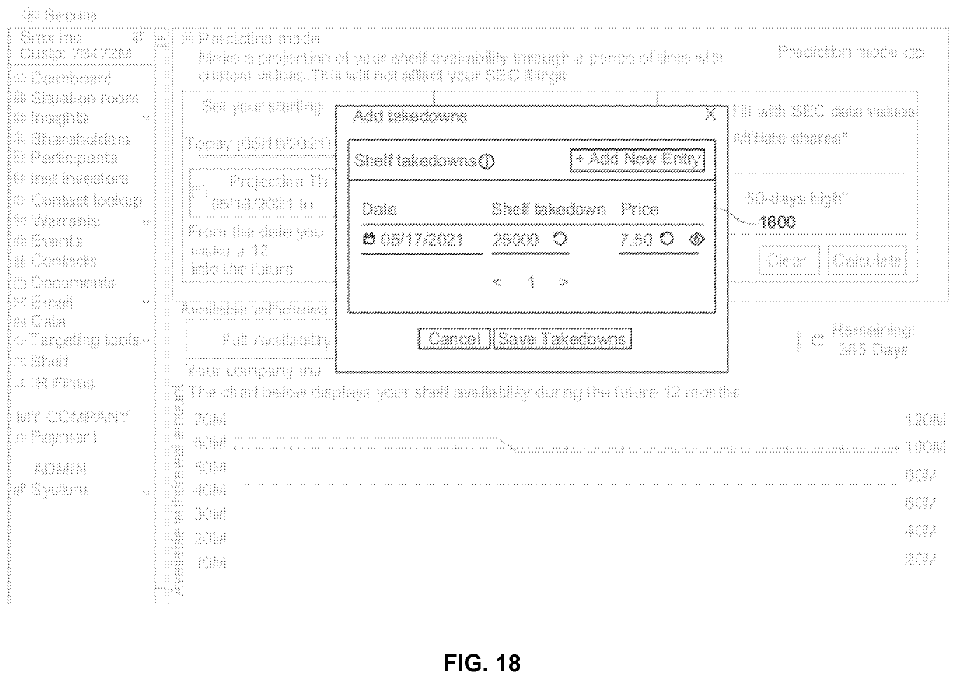

In some examples, the pricing value or forecast may be provided by user input via a GUI. An illustrative GUI is provided with FIGS. 16 and 18.

In some examples, the monetary value of the company may be determined. The monetary value may correspond with funds that users associated with the company or entity, and have immediate access to without initiating a takedown action (e.g., on-hand value). The monetary value or cash on-hand may be considered by the system when providing a suggestion for initiating a takedown action, which may result in raising additional money for the entity. When the monetary value or cash on-hand exceeds a threshold value, the system may generate a suggestion notification that the user does not raise money because of the available monetary value or cash on-hand. In some examples, a future takedown action may be avoided in response to this additional information.

In some examples, the user interactions may include data corrections to the processed data. The interactions may be stored with analytics data store 118 and used to update or amend existing data for an entity.

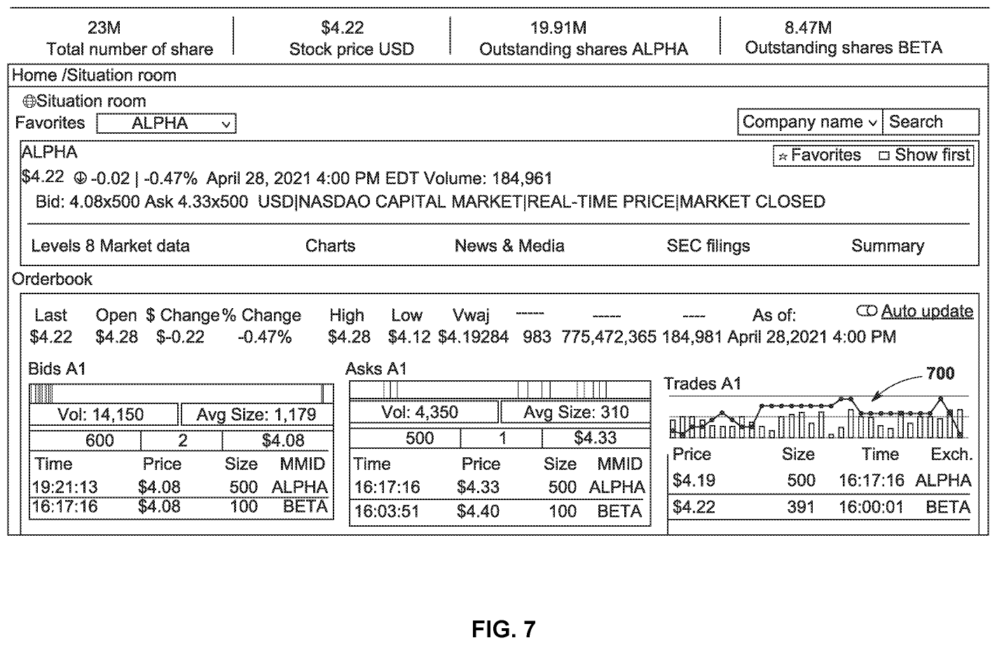

Illustrative user interfaces providing computational shelf forecasting are provided with FIGS. 6-19.

FIG. 6 is an illustrative user interface providing computational shelf forecasting, in accordance with the embodiments disclosed herein. For example, a user interface can provide an institution or company's details, such as name, address, phone number, sector, or ticker symbol for the entity. Other information may be included, for example, that originated in an SEC Form 3.

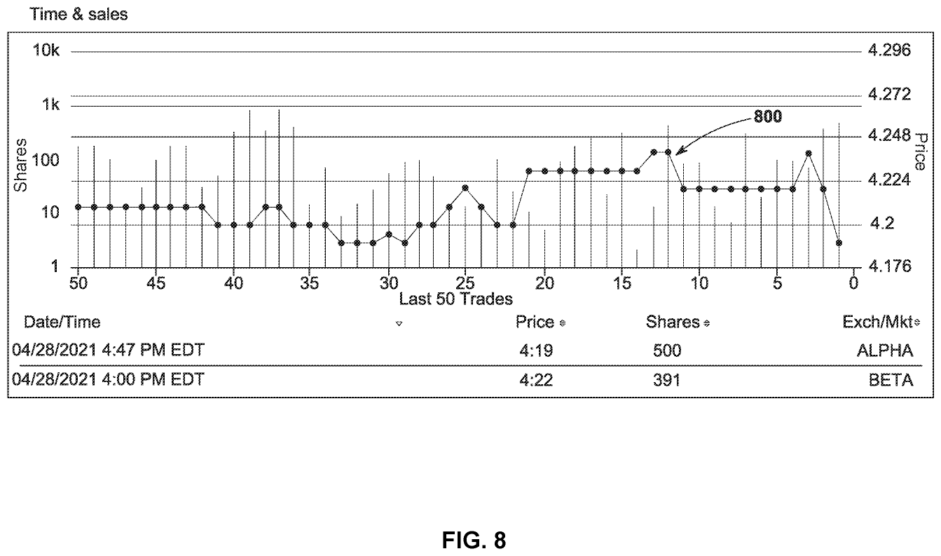

FIG. 7 is an illustrative user interface providing computational shelf forecasting, in accordance with the embodiments disclosed herein. For example, a user interface can include an overlay 700. For example, the underlying data can include original investment information and the overlay 700 may include additional investor data with executive's own insights or feedback. The insight may identify that the investor has stopped filing with the SEC and the executive knows his/her current status. The overlay 700 may include the information that was not filed with the SEC and the data can be added about the investor's current holdings that could be toggled on/off.

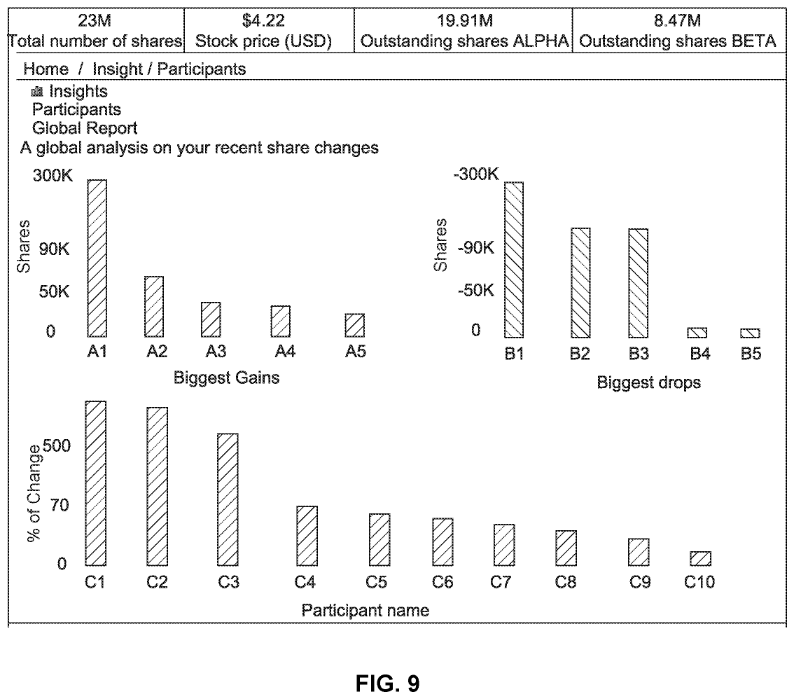

FIG. 8 is an illustrative user interface providing computational shelf forecasting, in accordance with the embodiments disclosed herein. An alternative example of an overlay 800 is provided.

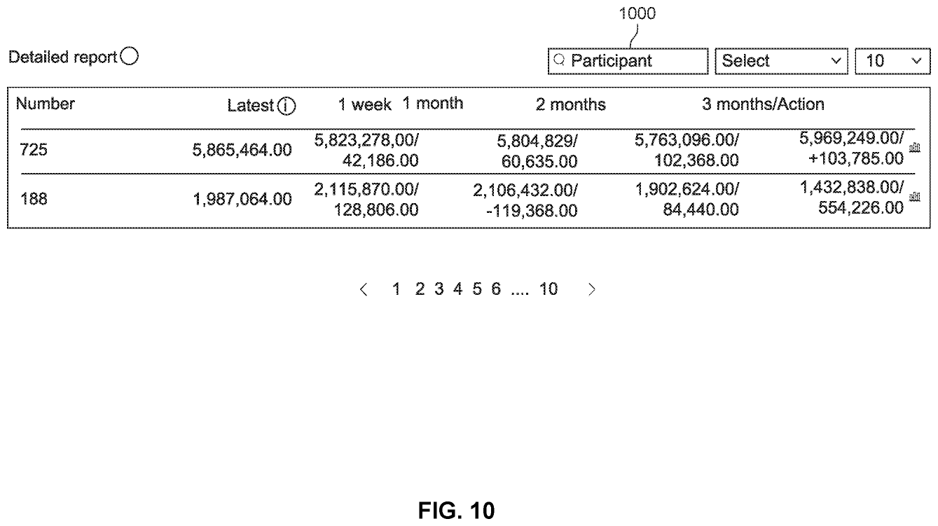

FIG. 9 is an illustrative user interface providing computational shelf forecasting, in accordance with the embodiments disclosed herein. An alternative example of participants are provided (e.g., A1-A5, B1-B5, C1-C10, etc.).

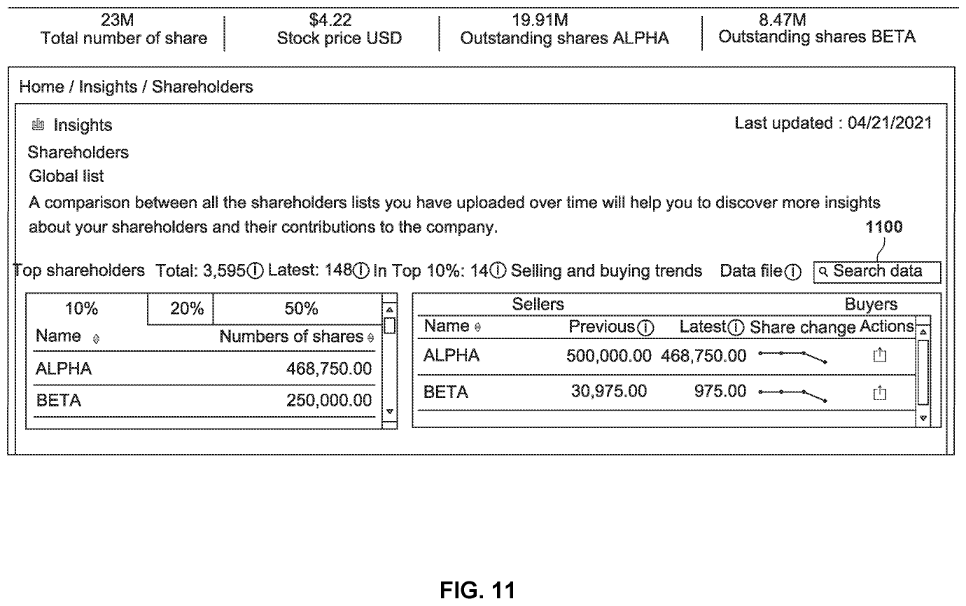

FIG. 10 is an illustrative user interface providing computational shelf forecasting, in accordance with the embodiments disclosed herein. For example, a user interface can include a search feature 1000. The search feature may receive a search query that it can submit to the analytics data store 118. The search query may search by attribute (e.g., companies in California), range (e.g., companies with a market cap of $300 M to $2B), levels of hierarchies (e.g., jump from Oil and gas industry companies to all Energy sector companies), and the like. Filters may be applied (e.g., add a state of California filter to a list of Investors). The query response may provide data relevant to the search query (e.g., a company or investor, lists of companies/investors based on their characteristics, etc.).

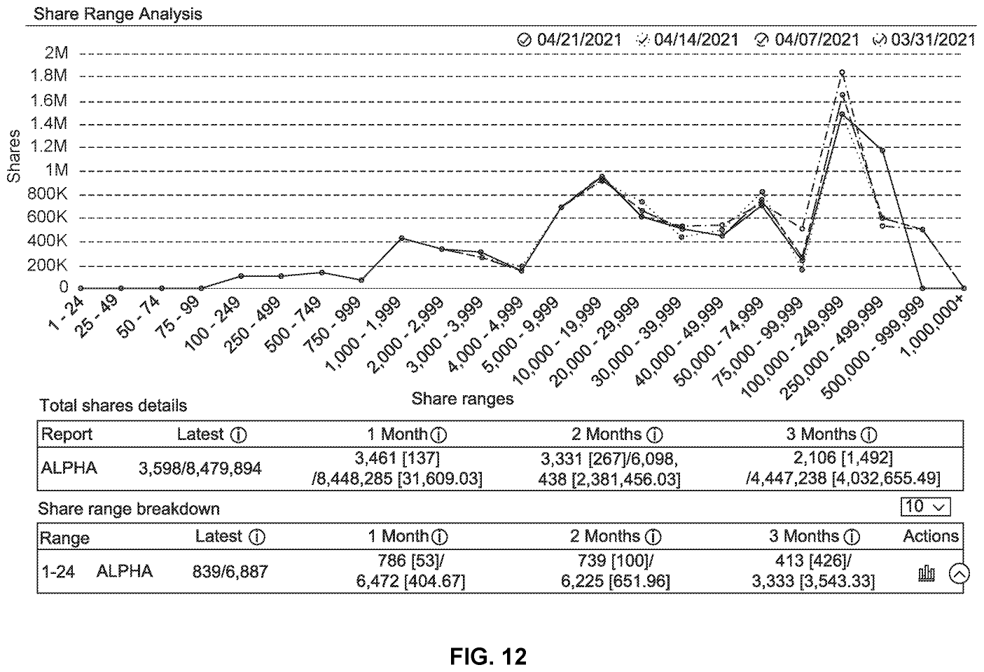

FIG. 11 is an illustrative user interface providing computational shelf forecasting, in accordance with the embodiments disclosed herein. An alternative example of a search feature 1100 is provided.

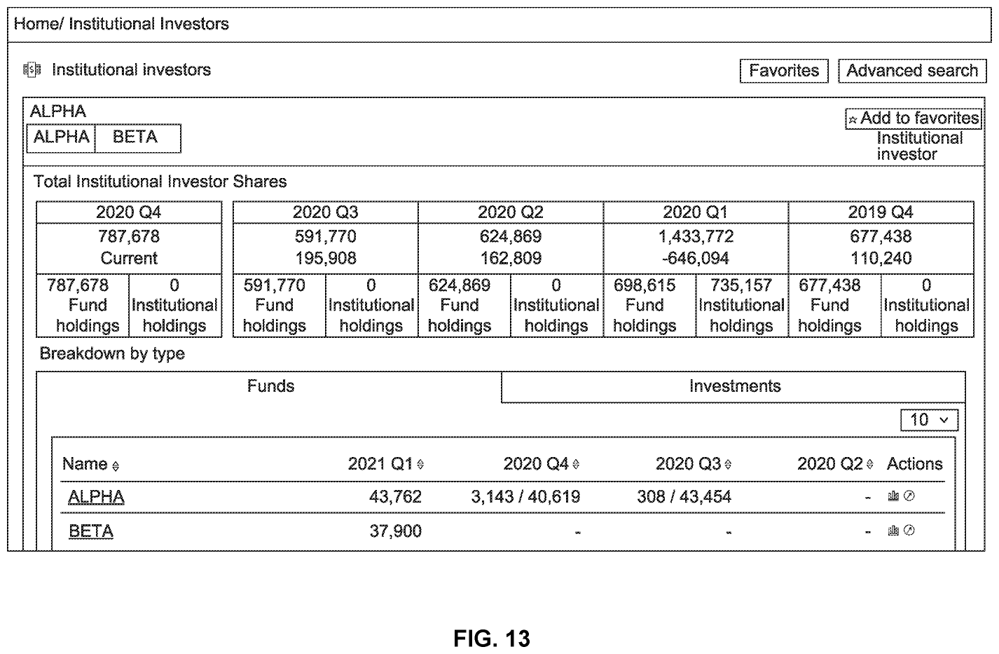

FIG. 12 is an illustrative user interface providing computational shelf forecasting, in accordance with the embodiments disclosed herein. For example, a user interface can provide a summary of an entity's outgoing investments. This covers the ability to explore data on the investments made by a single institution. More detailed use cases involved in this functionality can include, for example, current shares and value investor holds in each company (as of most recent filing), delta in shares for company since last filing, history of investor's shares in company and value over time, details of all the investor's filings, and the like.

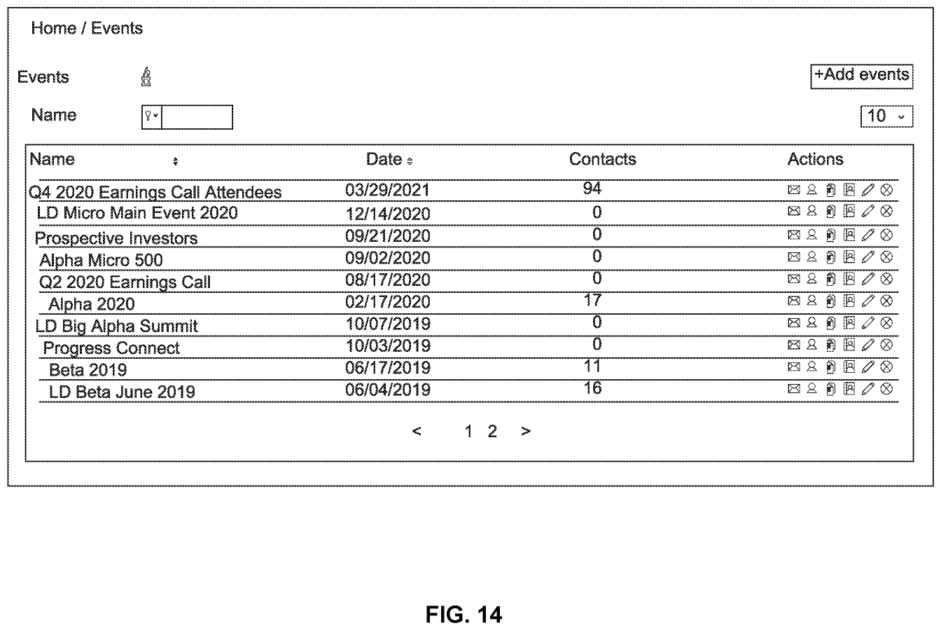

FIG. 13 is an illustrative user interface providing computational shelf forecasting, in accordance with the embodiments disclosed herein. For example, a user interface can provide a summary of an entity's institutional investors. This may provide the user with the ability to explore data on investment funds and investors that are involved with a single company. More detailed use cases involved in this functionality can include, for example, current shares and value for each investor (as of most recent filing), delta in shares since last filing, history of investor's shares and value over time, an indicator when most recent filing is old (longer than one quarter ago), details of each of the investor's filings in the company, and the like.

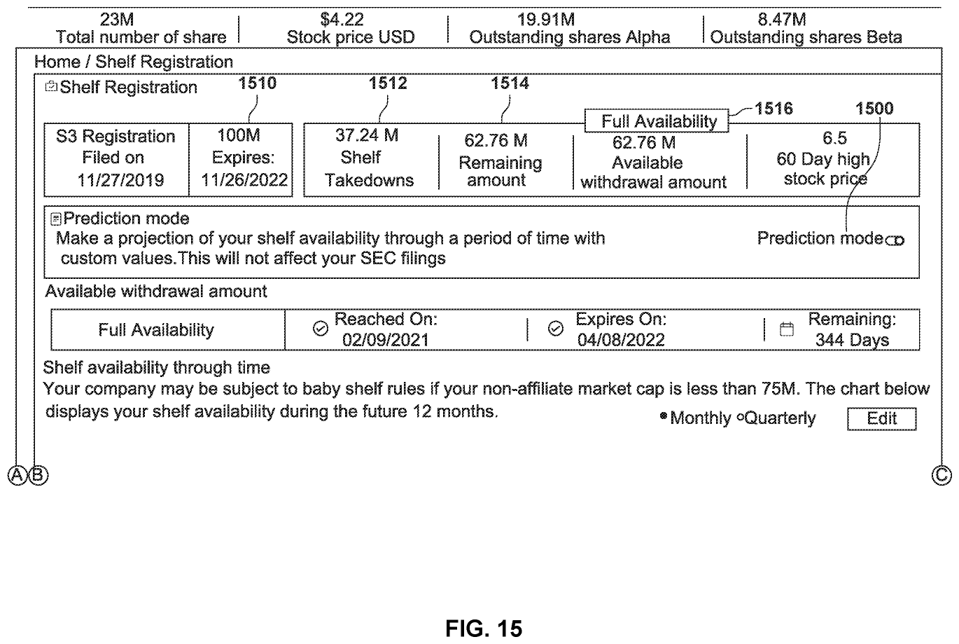

FIG. 14 is an illustrative user interface providing computational shelf forecasting, in accordance with the embodiments disclosed herein. The user interface may include information, for example, a date of an event requiring a financial statement. Actions may be implemented in response to the event, including automatically distributing a notification to a group of users, updating analytics data store 118, and the like.

FIG. 15 is an illustrative user interface providing computational shelf forecasting, in accordance with the embodiments disclosed herein. An illustrative shelf registration is provided.

As illustrated, a graphical user interface (GUI) can present the shelf data that was collected from corporate filing data store 130 (e.g., provided by SEC®, etc.). The bottom of the illustration may include the discrete data points from SEC, provided as daily basis data. Using the same data set, the information may also be plotted as graph. The data at the top of FIG. 15 may be aggregated data that can give the user a high level overview of the shelf calculation. In a forecasting mode, the user may enter future data points with the GUI and the system may use that data to extend the result date range to the desired period.

The GUI may include one or more tools, including tool 1500 to toggle on and off forecasting mode. When the toggle is off, the data provided by the GUI may include historical data for the entity without forecasting information.

Historical data may also be provided by the GUI. As illustrated, an S3 registration was filed for a public entity on Nov. 27, 2019 of $100 million dollar value 1510. The dollar value 1510 may correspond with an equity offering by the entity. The dollar value 1510 of the S3 registration may be reduced when one or more takedown actions occur. In this illustration, the takedown action corresponding with $37.24 million dollar value 1512 has occurred, which leaves a remaining value 1514 of $62.76 million. The full availability value 1516 of the equity offering may correspond with the remaining value 1514 of $62.76 million, since in this example, only a single takedown action has occurred for this offering.

The daily data may be repeated in the chart provided by the GUI. The first data line 1520 may correspond with an amount that the entity can perform one or more takedown actions from the shelf. The second data line 1522 may correspond with the non-affiliate market capitalization of the underlining equity. When the second data line 1522 crosses over the $75 million threshold value (e.g., corresponding with the baby shelf rules, discussed herein), the remaining value left from the original registration 1510 is not subject to the baby shelf limitations. These limitations may correspond with, for example, a value limit corresponding with the takedown action. In this example, the baby shelf corresponds with one-third the value of the equity offering (e.g., $33 million, etc.).

FIG. 16 is an illustrative user interfaces providing computational shelf forecasting, in accordance with the embodiments disclosed herein. In FIG. 16, the user may interact with the GUI to toggle the tool 1500 and turn on forecasting mode. When the toggle is on, the data provided by the GUI may include future data for the entity with forecasting information. In this illustration, no data has been provided to incorporate for the forecast, so the chart may be blank.

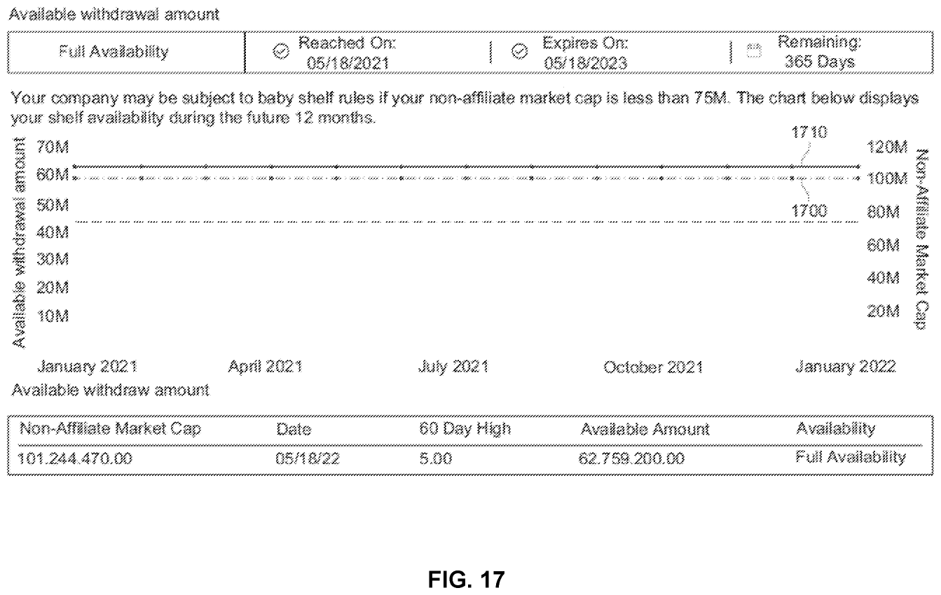

FIG. 17 is an illustrative user interfaces providing computational shelf forecasting, in accordance with the embodiments disclosed herein. In FIG. 17, the chart may be updated to show a constant value without any takedown actions. The full availability of the equity offering by the entity may be available and subject to baby shelf rules (e.g., under $75 million, etc.). In some examples, the shelf availability may be offered for one year after the entity has reached full availability.

Various data lines may be displayed. For example, a first data line 1700 may correspond with the remaining value 1514 of $62.76 million. A second data line 1710 may correspond with the non-affiliate market capitalization of the underlining equity in response to any future takedown actions. Since the user has not yet provided future takedown data, the second data line 1710 remains constant and unchanged.

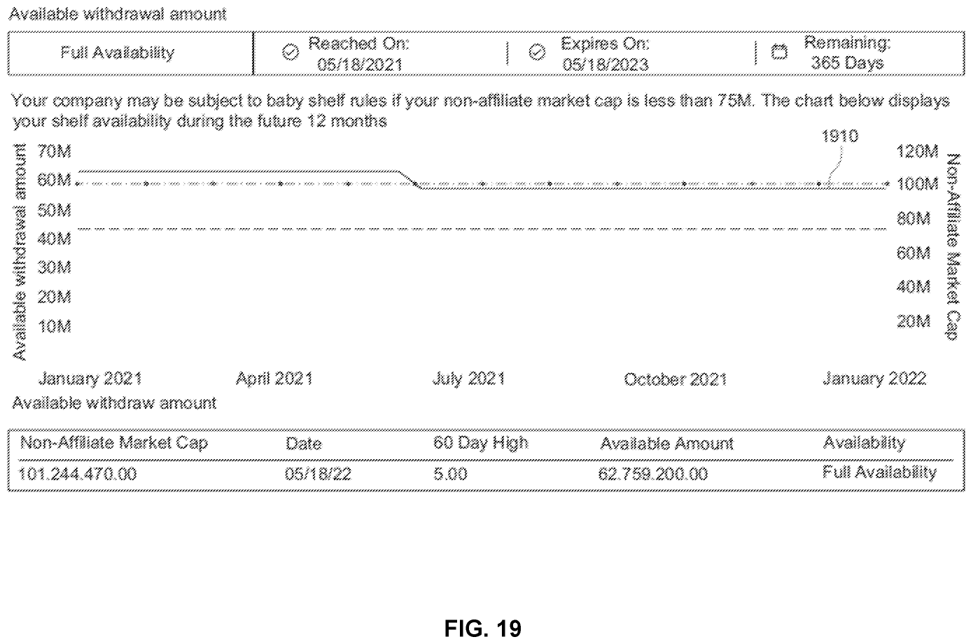

FIG. 18 is an illustrative user interface providing computational shelf forecasting, in accordance with the embodiments disclosed herein. In this example, a user may provide future takedown data using tool 1800. The future takedown data may correspond with a date (e.g., May 17, 2021), shelf takedown value (e.g., 250,000), and estimated price on that future date (e.g., $7.50, etc.). When the user saves the future takedown data, the GUI may be updated based on data available in the system, as illustrated in FIG. 19, which adjusts the second data line 1910 at a new value and future availability.

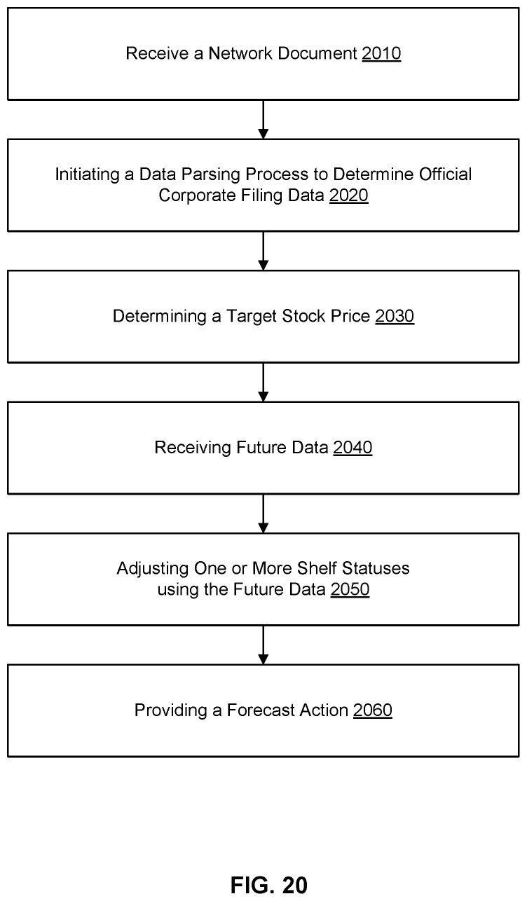

FIG. 20 is an illustrative process for providing computational shelf forecasting, in accordance with the embodiments disclosed herein. The method may be implemented by machine readable instructions executed by processor 104 of computational action system 102 of FIG. 1.

At 2010, a network document may be received. For example, computational action system 102 may receive a network document associated with a corporate entity. The network document may be stored in corporate filing data store 130.

At 2020, a data parsing process may be initiated to determine official corporate filing data. For example, computational action system 102 may initiate a data parsing process on the network document to determine official corporate filing data associated with the corporate entity.

In some examples, the official corporate filing data associated with the corporate entity comprises at least one of outstanding shares, affiliate shares, common shares, warrant data, shelf registration, and stock price.

At 2030, a target stock price may be determined. For example, computational action system 102 may determine a target stock price associated with a subset of shelf availability and a corresponding date of the target stock price. The determination of the stock price may be, at least in part, using the official corporate filing data associated with the corporate entity.

At 2040, future data may be received. For example, computational action system 102 may receive future data associated with the corporate entity. The future data may be received by the computational action system via a user interaction at a user interface.

At 2050, one or more shelf statuses may be adjusted using the future data. For example, computational action system 102 may adjust one or more shelf statuses using the future data.

At 2060, a forecast action may be provided. For example, computational action system 102 may provide a forecast action based on the one or more shelf statuses.

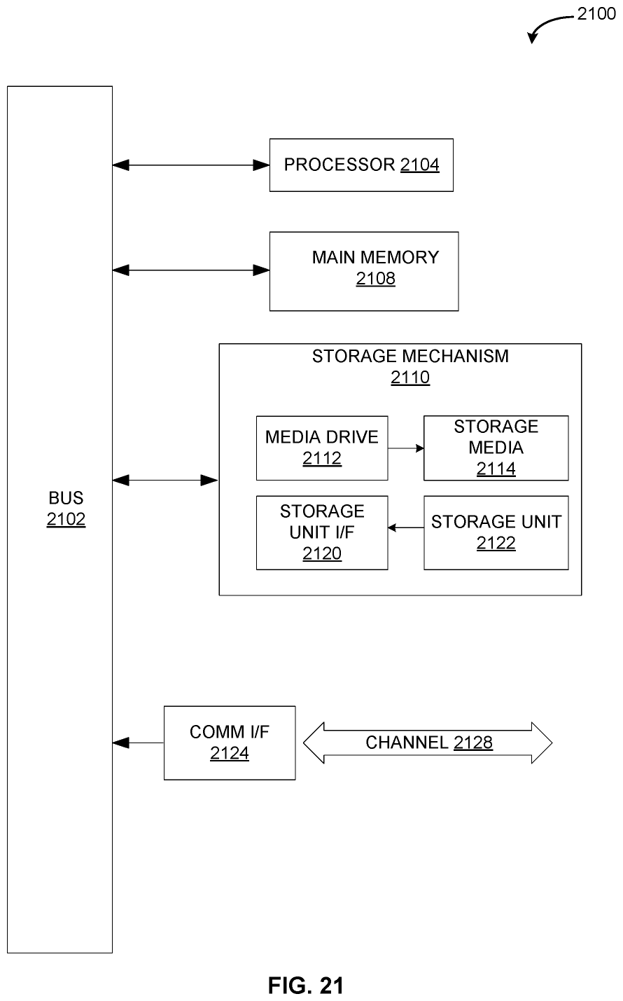

In some examples, the method may further comprise receiving a second network document associated with the corporate entity; initiating a second data parsing process on the second network document to determine a new shelf status; and updating the one or more shelf statuses based on the new shelf status. In some examples, the method may further comprise transmitting a notification to the user interface associated with the updated one or more shelf statuses.

Where components, logical circuits, or engines of the technology are implemented in whole or in part using software, in one embodiment, these software elements can be implemented to operate with a computing or logical circuit capable of carrying out the functionality described with respect thereto. One such example logical circuit is shown in FIG. 21. Various embodiments are described in terms of this example logical circuit 2100. After reading this description, it will become apparent to a person skilled in the relevant art how to implement the technology using other logical circuits or architectures.

Referring now to FIG. 21, computing system 2100 may represent, for example, computing or processing capabilities found within desktop, laptop, and notebook computers; hand-held computing devices (PDA's, smart phones, cell phones, palmtops, etc.); mainframes, supercomputers, workstations, or servers; or any other type of special-purpose or general-purpose computing devices as may be desirable or appropriate for a given application or environment. Logical circuit 2100 might also represent computing capabilities embedded within or otherwise available to a given device. For example, a logical circuit might be found in other electronic devices such as, for example, digital cameras, navigation systems, cellular telephones, portable computing devices, modems, routers, WAPs, terminals and other electronic devices that might include some form of processing capability.

Computing system 2100 might include, for example, one or more processors, controllers, control engines, or other processing devices, such as a processor 2104. Processor 2104 might be implemented using a general-purpose or special-purpose processing engine such as, for example, a microprocessor, controller, or other control logic. In the illustrated example, processor 2104 is connected to a bus 2102, although any communication medium can be used to facilitate interaction with other components of logical circuit 2100 or to communicate externally.

Computing system 2100 might also include one or more memory engines, simply referred to herein as main memory 2108. For example, preferably random-access memory (RAM) or other dynamic memory, might be used for storing information and instructions to be executed by processor 2104. Main memory 2108 might also be used for storing temporary variables or other intermediate information during execution of instructions to be executed by processor 2104. Logical circuit 2100 might likewise include a read only memory (“ROM”) or other static storage device coupled to bus 2102 for storing static information and instructions for processor 2104.

The computing system 2100 might also include one or more various forms of information storage mechanism 2110, which might include, for example, a media drive 2112 and a storage unit interface 2120. The media drive 2112 might include a drive or other mechanism to support fixed or removable storage media 2114. For example, a hard disk drive, a floppy disk drive, a magnetic tape drive, an optical disk drive, a CD or DVD drive (R or RW), or other removable or fixed media drive might be provided. Accordingly, storage media 2114 might include, for example, a hard disk, a floppy disk, magnetic tape, cartridge, optical disk, a CD or DVD, or other fixed or removable medium that is read by, written to, or accessed by media drive 2112. As these examples illustrate, the storage media 2114 can include a computer usable storage medium having stored therein computer software or data.

In alternative embodiments, information storage mechanism 2140 might include other similar instrumentalities for allowing computer programs or other instructions or data to be loaded into logical circuit 2100. Such instrumentalities might include, for example, a fixed or removable storage unit 2122 and an interface 2120. Examples of such storage units 2122 and interfaces 2120 can include a program cartridge and cartridge interface, a removable memory (for example, a flash memory or other removable memory engine) and memory slot, a PCMCIA slot and card, and other fixed or removable storage units 2122 and interfaces 2120 that allow software and data to be transferred from the storage unit 2122 to logical circuit 2100.

Logical circuit 2100 might also include a communications interface 2124. Communications interface 2124 might be used to allow software and data to be transferred between logical circuit 2100 and external devices. Examples of communications interface 2124 might include a modem or soft modem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 2124 might typically be carried on signals, which can be electronic, electromagnetic (which includes optical) or other signals capable of being exchanged by a given communications interface 2124. These signals might be provided to communications interface 2124 via a channel 2128. This channel 2128 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 2108, storage unit 2120, media 2114, and channel 2128. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the logical circuit 2100 to perform features or functions of the disclosed technology as discussed herein.

Although FIG. 21 depicts a computer network, it is understood that the disclosure is not limited to operation with a computer network, but rather, the disclosure may be practiced in any suitable electronic device. Accordingly, the computer network depicted in FIG. 21 is for illustrative purposes only and thus is not meant to limit the disclosure in any respect.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical, or physical partitioning and configurations can be implemented to implement the desired features of the technology disclosed herein. Also, a multitude of different constituent engine names other than those depicted herein can be applied to the various partitions.

Additionally, with regard to flow diagrams, operational descriptions and method claims, the order in which the steps are presented herein shall not mandate that various embodiments be implemented to perform the recited functionality in the same order unless the context dictates otherwise.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for providing computational shelf forecasting, the method comprising:
receiving, by a computational action system, a network document associated with a corporate entity;
initiating a data parsing process on the network document to determine official corporate filing data associated with the corporate entity;
determining a target stock price associated with a subset of shelf availability and a corresponding date of the target stock price based on at least the official corporate filing data associated with the corporate entity;
receiving, by the computational action system via a user interaction at a user interface, future data associated with the corporate entity;
adjusting one or more shelf statuses using the future data; and
providing a forecast action based on the one or more shelf statuses.

2. The method of claim 1, wherein the official corporate filing data associated with the corporate entity comprises at least one of outstanding shares, affiliate shares, common shares, warrant data, shelf registration, and stock price.

3. The method of claim 1, further comprising:
receiving a second network document associated with the corporate entity;
initiating a second data parsing process on the second network document to determine a new shelf status; and
updating the one or more shelf statuses based on the new shelf status.

4. The method of claim 3, further comprising:
transmitting a notification to the user interface associated with the updated one or more shelf statuses.

5. The method of claim 1, wherein the data parsing process generates a document-term matrix that includes a weighting of terms from the network document.

6. The method of claim 1, wherein the network document is a financial form filed or published with Securities and Exchange Commission (SEC).

7. The method of claim 6, wherein the network document is limited to one of eight different filing types within a predetermined time frame.

8. A computational action system for providing computational shelf forecasting, comprising:
a memory;
one or more processors that are coupled to the memory and configured to execute machine readable instructions stored in the memory for performing the method comprising:
receiving, by the computational action system, a network document associated with a corporate entity;
initiating a data parsing process on the network document to determine official corporate filing data associated with the corporate entity;
determining a target stock price associated with a subset of shelf availability and a corresponding date of the target stock price based on at least the official corporate filing data associated with the corporate entity;
receiving, by the computational action system via a user interaction at a user interface, future data associated with the corporate entity;
adjusting one or more shelf statuses using the future data; and
providing a forecast action based on the one or more shelf statuses.

9. The computational action system of claim 8, wherein the official corporate filing data associated with the corporate entity comprises at least one of outstanding shares, affiliate shares, common shares, warrant data, shelf registration, and stock price.

10. The computational action system of claim 8, wherein the one or more processors perform the method further comprising:
receiving a second network document associated with the corporate entity;
initiating a second data parsing process on the second network document to determine a new shelf status; and
updating the one or more shelf statuses based on the new shelf status.

11. The computational action system of claim 10, wherein the one or more processors perform the method further comprising:
transmitting a notification to the user interface associated with the updated one or more shelf statuses.

12. The computational action system of claim 8, wherein the data parsing process generates a document-term matrix that includes a weighting of terms from the network document.

13. The computational action system of claim 8, wherein the network document is a financial form filed or published with Securities and Exchange Commission (SEC).

14. The computational action system of claim 13, wherein the network document is limited to one of eight different filing types within a predetermined time frame.

15. A non-transitory computer-readable storage medium storing a plurality of instructions executable by one or more processors, the plurality of instructions when executed by the one or more processors cause the one or more processors to:
receive a network document associated with a corporate entity;
initiate a data parsing process on the network document to determine official corporate filing data associated with the corporate entity;
determine a target stock price associated with a subset of shelf availability and a corresponding date of the target stock price based on at least the official corporate filing data associated with the corporate entity;
receive, via a user interaction at a user interface, future data associated with the corporate entity;
adjust one or more shelf statuses using the future data; and
provide a forecast action based on the one or more shelf statuses.

16. The computer-readable storage medium of claim 15, wherein the official corporate filing data associated with the corporate entity comprises at least one of outstanding shares, affiliate shares, common shares, warrant data, shelf registration, and stock price.

17. The computer-readable storage medium of claim 15, wherein the one or more processors further:
receive a second network document associated with the corporate entity;
initiate a second data parsing process on the second network document to determine a new shelf status; and
update the one or more shelf statuses based on the new shelf status.

18. The computer-readable storage medium of claim 17, wherein the one or more processors further:
transmit a notification to the user interface associated with the updated one or more shelf statuses.

19. The computer-readable storage medium of claim 15, wherein the data parsing process generates a document-term matrix that includes a weighting of terms from the network document.

20. The computer-readable storage medium of claim 15, wherein the network document is a financial form filed or published with Securities and Exchange Commission (SEC).
